(19) United States
(12) Patent Application Publication
(10) Pub. No.: US 2018/0319255 A1
(43) Pub. Date: Nov. 8, 2018

(54) AIR VENT FOR A PASSENGER COMPARTMENT OF A MOTOR VEHICLE

(71) Applicant: fischer automotive systems GmbH & Co. KG, Horb a.N. (DE)

(72) Inventors: Ulf-Lothar Bastian, Pfalzgrafenweiler (DE); Falk Schaal, Freudenstadt (DE)

(21) Appl. No.: 15/943,145

(22) Filed: Apr. 2, 2018

(30) Foreign Application Priority Data
May 3, 2017 (DE) 10 2017 109 429.8
Oct. 24, 2017 (DE) 10 2017 124 874.9

(51) Int. Cl. B60H 1/34; B60H 1/00

(52) U.S. Cl. CPC B60H 1/3421; B60H 1/00564

(57) ABSTRACT

An air vent for ventilating a passenger compartment of a motor vehicle, including a rectangular housing and a rectangular air outlet opening. So as to guide an air current and so as to control an air volume, a flow-around body is proposed that can be displaced longitudinally and transversely in the housing and also be used to close the air outlet opening.

### CROSS-REFERENCE TO RELATED APPLICATIONS

This application claims priority under 35 USC § 119 to German Patent Application No. 10 2017 109 429.8, filed on May 3, 2017, and German Patent Application No. 10 2017 124 874.9, filed on Oct. 24, 2017, the entire disclosures of which are incorporated herein by reference.

### Technical Filed

An air vent is provided, in particular, for a passenger compartment of a motor vehicle, but can also be used for passenger compartments of other land vehicles, aircraft or watercraft and, generally speaking, for venting or ventilating rooms.

### BACKGROUND ART

An air vent comprising a rectangular tube-shaped housing is known from the patent DE 10 2013 210 055 B3, which initially widens in an S-shaped manner toward an air outlet opening and then tapers in an arc-shaped manner to the air outlet opening. In a thus widened section of the housing, a flow-around body having an egg-shaped profile is disposed, which divides the housing into two mirror-image channels. An adjustable air deflector is disposed on an incident flow side of the flow-around body facing away from the air outlet opening of the housing and can be used to selectively block one of the two channels to varying degrees, whereby a ratio of air volumes flowing through the two channels can be set. Selectively, one of the two channels can be blocked entirely by way of the air deflector. The ratio of the air volumes flowing through the two channels formed by the flow-around body influences a direction of flow out of the air vent.

An air vent comprising a likewise tube-shaped housing is known from the patent application EP 1 454 780 A2, including a ball-shaped section having an air inlet opening and an opposing air outlet opening. A two-dimensionally curved shield is disposed in the ball-shaped section, the shield being adjustable in a flow direction and used to close the air inlet opening.

### SUMMARY

An object of the invention is to propose an air vent having combined air guidance and air volume control.

An air vent as described herein includes a tubular housing having an air inlet opening and an air outlet opening and a flow-around body disposed in the housing. The air inlet opening and the air outlet opening refer to an intended flow through the air vent. In a motor vehicle or another vehicle, the air outlet opening opens into a passenger compartment, or in any case air flows through the air inlet opening into the air vent and out of the air outlet opening into the passenger compartment. A cross-section of the housing, and in particular an inner cross-section, changes over a length of the housing, wherein the length of the housing is the extension thereof in the flow direction, wherein the housing and the flow direction may be straight or not straight. The cross-section is perpendicular to the flow direction through the housing.

The flow-around body is, in particular, a profiled body, which in particular divides the housing into two channels on two opposing sides of the flow-around body, or into an annular channel that surrounds the flow-around body, and can also be considered to be an air splitter. So as to close the air vent, the flow-around body can be displaced into a closed position closing the air outlet opening.

In particular, for air guidance, the air vent according to the invention comprises an air-deflecting device, which can be adjusted transversely to the flow direction through the housing, whereby a flow cross-section between the flow-around body and the housing can be decreased on one side of the flow-around body, and increased on an opposing side of the flow-around body. Corresponding to the flow cross-sections on the two sides of the flow-around body, the air volumes of a flow through the housing of the air vent change on the two sides of the flow-around body, however there is not necessarily a linear correlation between the flow cross-sections and the air volumes. If the housing tapers toward the air outlet opening such that air currents in the housing flow toward one another at an angle on the two opposing sides of the flow-around body, the ratio of the air volumes on the two sides of the flow-around body influences a direction of a flow of air out of the air outlet opening of the air vent. The air-deflecting device does not have to be adjustable exactly transversely to the flow direction through the air vent, but may also have a component in the flow direction, which is to say obliquely to the flow direction. Another option, according to the invention, for adjusting the air-deflecting device transversely to the flow direction through the air vent is that the air-deflecting device be pivotable, or that a component of the air-deflecting device be pivotable, about a pivot axis extending transversely to the housing of the air vent.

One embodiment of the invention provides for the flow-around body itself to be displaceable transversely or obliquely with respect to the flow direction through the housing and/or to be pivotable about a pivot axis extending transversely to the housing, and to form the air-deflecting device.

Another embodiment of the invention provides for an air-deflecting element that is displaceable transversely or obliquely with respect to the flow direction through the housing to form the air-deflecting device. In this case, the flow-around body and the air-deflecting element are different parts.

One refinement provides for an air-deflecting element that is disposed in a recess of the flow-around body and displaceable transversely to the flow direction through the housing of the air vent. Due to the transverse displaceability, the air-deflecting element on the one side or on the opposite side can be adjusted so as to protrude from the flow-around body, thereby blocking the flow cross-section on the respective side of the flow-around body substantially, entirely or not at all. It is also conceivable that the air-deflecting element protrudes from the flow-around body on both sides, and as a result of a transverse adjustment increases the flow cross-section on one side and decreases the flow cross-section on the opposite side.

One embodiment of the invention provides for the air-deflecting element having a W-shaped cross-section. The cross-section of the air-deflecting element runs in the flow direction, or in a longitudinal plane of the air vent.

The flow-around body is preferably located closer to the air outlet opening than to the air inlet opening, so that this influences the flow through the housing of the air vent at or close to the air outlet opening and can be displaced into the closed position closing the air outlet opening.

One embodiment of the invention provides for the flow-around body to have an airfoil profile, and in particular a symmetrical airfoil profile or a half symmetrical airfoil profile. A half airfoil profile denotes a transversely “cut” airfoil profile, wherein the airfoil profile can be “cut” in any arbitrary location and does not have to be “cut” in the center. In particular, a blunt side of the half airfoil profile faces the air outlet opening and closes the air outlet opening in the closed position.

An alternative embodiment provides for the flow-around body having a V-shaped profile, which comprises a rounded area instead of an edge on an incident flow side facing the air inlet opening and, in particular symmetrical, a trapezoidal profile on an outflow side facing the air outlet opening.

In a preferred embodiment, the housing and/or the flow-around body have rectangular cross-sections. In particular, the air outlet opening is slot-shaped (a so-called “slot nozzle”). An oval cross-section for the housing and/or for the flow-around body is also possible, for example. In general, the housing and/or the flow-around body have different dimensions perpendicularly to one another and transverse to the flow direction. However, circular and square cross-sections are also possible. As mentioned above, the cross-sections are perpendicular to the flow direction through the housing of the air vent, while the profile is a contour as viewed from one side, which is to say a longitudinal section in the flow direction.

### BRIEF DESCRIPTION OF THE DRAWINGS

The invention will be described hereafter in greater detail based on exemplary embodiments shown in the drawings. In the drawings:

FIG. 1 shows an air vent according to the invention in a perspective illustration, cut in a longitudinal plane;

FIG. 2 shows the longitudinal section of the air vent from FIG. 1, as viewed from one side;

FIG. 3 shows the air vent from FIG. 2 with an adjusted flow-around body;

FIG. 4 shows the air vent from FIG. 2 in a closed position;

FIG. 5 shows a second exemplary embodiment of an air vent according to the invention in a longitudinal section corresponding to FIG. 2, as viewed from one side;

FIG. 6 shows the air vent from FIG. 5 with an adjusted air-deflecting element;

FIG. 7 shows the air vent from FIG. 5 in a closed position;

FIG. 8 shows a third exemplary embodiment of an air vent according to the invention in a longitudinal section corresponding to FIG. 2, as viewed from one side;

FIG. 9 shows the air vent from FIG. 8 with an adjusted air-deflecting element; and

FIG. 10 shows the air vent from FIG. 8 in a closed position.

The figures are schematic and simplified illustrations to provide an understanding of the invention, and to describe the invention.

### DETAILED DESCRIPTION

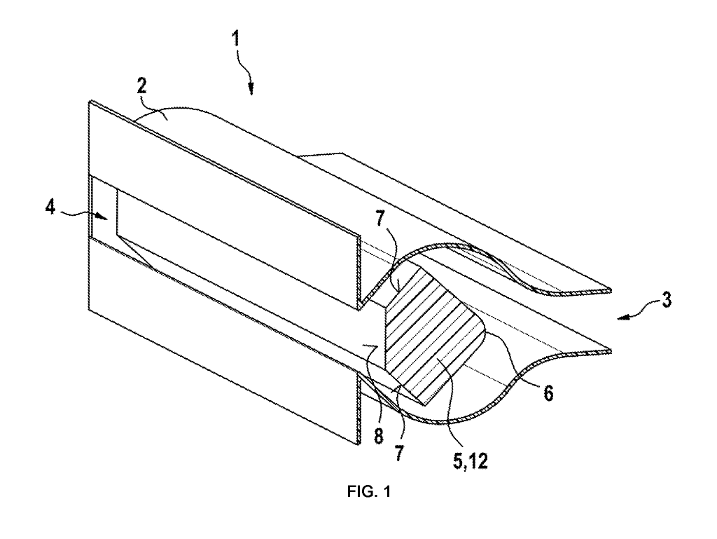

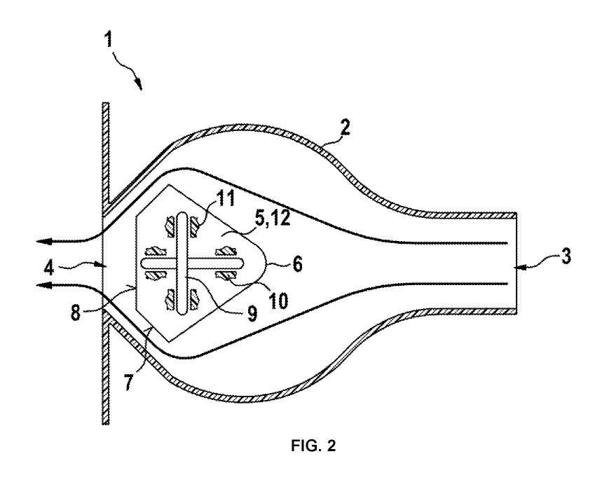

The air vent 1 according to the invention shown in FIGS. 1 to 4 is provided for ventilating, heating, and optionally cooling a passenger compartment of a motor vehicle, which is not shown, and for installation in a dashboard of the motor vehicle. It comprises a tubular housing 2 having a rectangular cross-section, including a rectangular air inlet opening 3 and a likewise rectangular air outlet opening 4. The air outlet opening 4 is low and wide in the exemplary embodiment and can also be considered to be slot-shaped, and the air vent 1 or the housing 2 thereof can be considered to be a slot nozzle. The path from the air inlet opening 3 to the air outlet opening 4 defines a longitudinal direction of the housing 2.

At a distance from the air inlet opening 3, the housing 2 widens at the top and bottom in an S-shaped manner, and thereafter tapers again, initially in an arc-shaped manner and then in an oblique and linear manner, up to the air outlet opening 4. In the exemplary embodiment, the housing 2 has the same width across the entire length thereof. A rectangular shape is not mandatory for the air vent 1 or the housing 2 thereof. For example, the housing 2 may also comprise a circular air inlet opening 3 and change the cross-section thereof from round to rectangular from the air inlet opening 3 to the air outlet opening 4 (not shown). Housing cross-sections other than round or rectangular are also possible (not shown).

In an expanded section formed by the widening and the tapering, the housing 2 of the air vent 1 comprises a flow-around body 5 having a horizontal V profile including a rounded edge 6. “Horizontal” shall be understood to mean that a center line of the V runs in the longitudinal direction of the housing 2. The rounded edge 6 is located on an incident flow side of the flow-around body 5 facing the air inlet opening 3. The flow-around body 5 is tapered toward the air outlet opening 4, having two sloped surfaces 7, and ends with an end face 8 extending transversely to the housing 2, which is as large as the air outlet opening 4. The two sloped surfaces 7 and the end face 8 form a trapezoid, as viewed from the side, so that the flow-around body 5, due to the V profile thereof on the incident flow side and the trapezoidal profile on an outflow side facing the air outlet opening 4, can be considered to have a V-shaped profile and a trapezoidal profile.

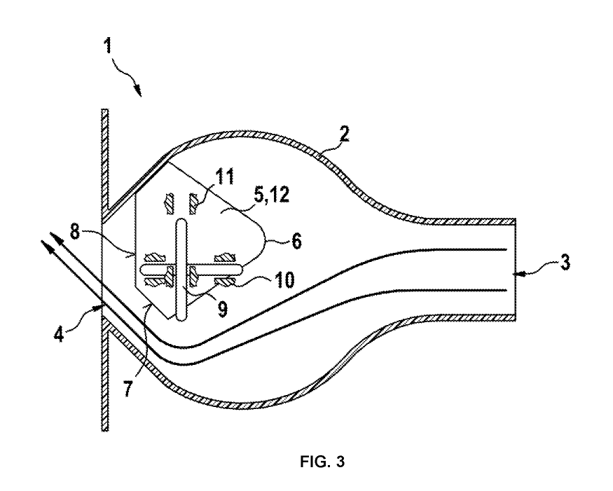

The flow-around body 5 can be adjusted in the longitudinal direction and transversely to the housing 2 on both sides by way of a cross table 9. A longitudinal guide 10 of the cross table 9 is fixed to the housing, and a transverse guide 11 is fixed to the flow-around body, or vice versa. The transverse guide 11 allows the flow-around body 5 to be moved, or generally speaking to be displaced, upward and downward (not shown) until it makes contact with the inside of the housing 2, as can be seen in FIG. 3. If the flow-around body 5 is displaced upward in the housing 2, an increasing amount of air flows past the flow-around body 5 at the bottom of the housing 2 relative to the top. If the flow-around body 5 rests against the housing 2 at the top, the entire air volume flows through the housing 2 at the bottom and past the flow-around body 5. Since the housing 2 is tapered toward the air outlet opening 4, which is to say converges obliquely from the top and from the bottom, the air current exits the housing 2 of the air vent 1 obliquely upward through the air outlet opening 4. The conditions are reversed when the flow-around body 5 is displaced upward. The upward or downward displacement of the flow-around body 5 changes a ratio of air volumes flowing around the flow-around body 5 at the bottom and at the top, and influences a flow direction of the air out of the air outlet opening 4. As a result of being adjustable transversely to the housing 2, which changes the ratio of the air volumes flowing around the flow-around body 5 at the bottom and at the top, the flow-around body 5 in FIGS. 1 to 4 also forms an air-deflecting device 12. The displacement of the flow-around body 5 upward or downward can also be considered to be an adjustment transverse to the housing 2 since this occurs transversely to the longitudinal direction of the housing 2.

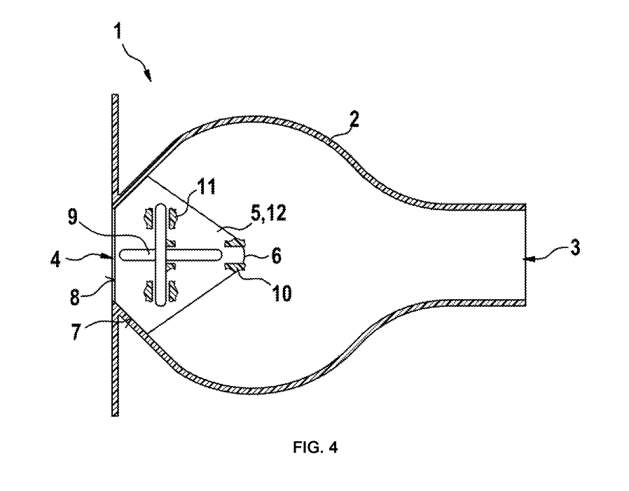

So as to close the air outlet opening 4, the flow-around body 5 is moved in the direction of the air outlet opening 4 into a closed position until the sloped surfaces 7 thereof are seated against the inside of the housing 2, and the end face 8 thereof closes the air outlet opening 4 of the housing 2, as is shown in FIG. 4. The moving of the flow-around body 5 can, generally speaking, also be considered to be a displacement. Even when the air outlet opening 4 is open, the flow-around body 5 is located close to the air outlet opening 4, located closer to the air outlet opening 4 than to the air inlet opening 3, and located entirely or predominantly in the portion of the housing 2 which tapers toward the air outlet opening 4. Displacement of the flow-around body 5 in the direction of the air outlet opening 4 decreases flow cross-sections at the top and at the bottom between the flow-around body 5 and the housing 2, so that the air volume flowing through the housing 2 of the air vent 1 can be adjusted by the displacement of the air vent 5 in the longitudinal direction of the housing 2.

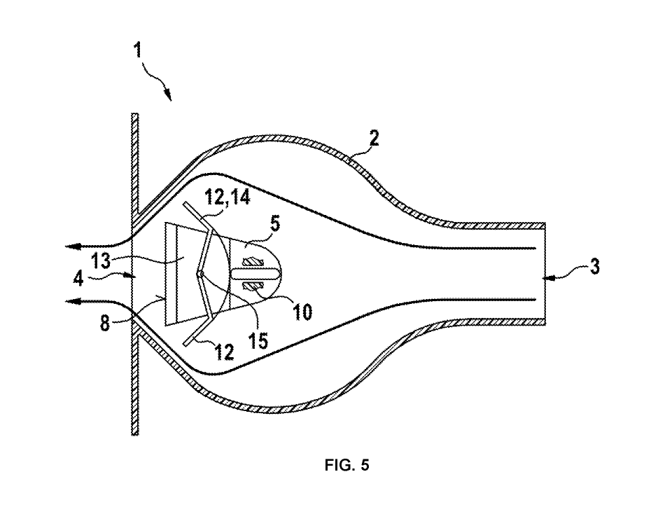

The following description of FIGS. 5 to 7 and 8 to 10 uses identical reference numerals for elements that coincide with FIGS. 1 to 4. A housing 2 of the air vent 1 from FIGS. 5 to 7 is designed identically to the housing 2 of the air vent 1 from FIGS. 1 to 4. In an expanded region formed by an S-shaped widening and a subsequent tapering, initially in an arc-shaped manner and then in an oblique and linear manner, the housing 2 of the air vent 1 from FIGS. 5 to 7, similarly to FIGS. 1 to 4, comprises a flow-around body 5. In FIGS. 5 to 7, the flow-around body 5 has a half symmetrical airfoil profile facing the air inlet opening 3. “Half” shall be understood to mean that the airfoil profile ends with a straight end face 8 on an outflow side facing away from the air outlet opening 4, which is transverse in the housing 2 and as large as the air outlet opening 4.

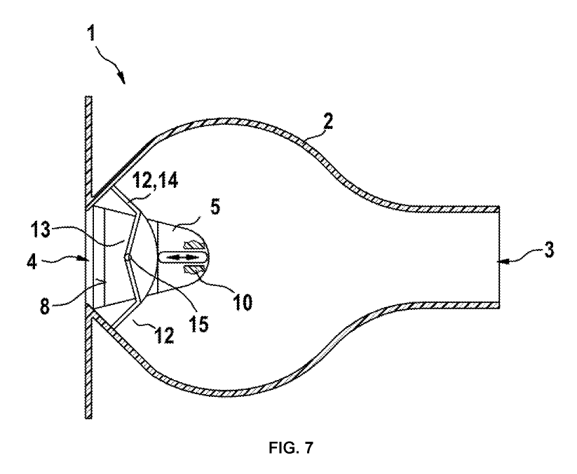

In FIGS. 5 to 7, the flow-around body 5 can be moved by way of a longitudinal guide 10, designed as a sliding guide, in a longitudinal direction of the housing 2 into a closed position shown in FIG. 7, in which the end face 8 of the flow-around body 5 is located in the air outlet opening 4 of the housing 2 of the air vent 1 and closes the air outlet opening 4. Due to the movement, which may also be considered a displacement, in the longitudinal direction of the housing 2, flow cross-sections at the top and at the bottom between the flow-around body 5 and the housing 2 can be decreased and increased, and thus an air volume flowing through the housing 2 of the air vent 1 can be controlled.

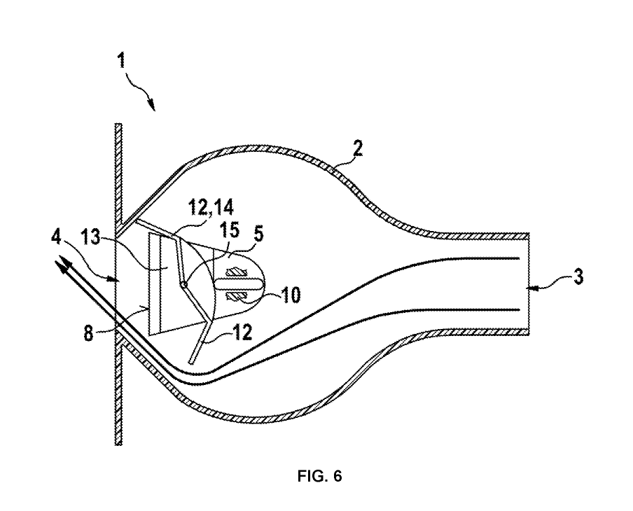

The flow-around body 5 of the air vent 1 from FIGS. 5 to 7 includes a recess 13, which is continuous across a width of the flow-around body 5 and through the flow-around body 5 from the top to the bottom. An air-deflecting element 14, which forms an air-deflecting device 12 of the air vent 1, is disposed in the recess 13. The air-deflecting element 14 has a cross-section of an upright W and can be pivoted upward and downward about a pivot axis 15 on the flow-around body 5 which extends in a longitudinal direction of the flow-around body 5, and thus transversely to the housing 2. In the exemplary embodiment, the air-deflecting element 14 protrudes from the flow-around body 5 at the top and at the bottom; however, embodiments in which the air-deflecting element 14 protrudes from the flow-around body 5 only toward the top or toward the bottom when it is pivoted upward or downward (not shown) are also possible. Pivoting the air-deflecting element 14, as shown in FIG. 6, downward or upward decreases a flow cross-section between the flow-around body 5 and the housing 2 at the top, and increases the flow cross-section at the bottom, or vice versa, whereby it is possible to vary a ratio of the air volumes that flow around the flow-around body 5 in the housing 2 at the bottom and at the top. As a result of the housing 2 tapering obliquely toward the air outlet opening 4, a direction of the air flow out of the air outlet opening 4 changes obliquely upward or downward. The air-deflecting element 14 can be pivoted until making contact in the housing 2 at the top or at the bottom, whereby the flow cross-section at the top or at the bottom on the flow-around body 5 can be closed, so that air can flow past the flow-around body 5 only at the bottom or at the top. The pivoting of the air-deflecting element 14 can, generally speaking, also be considered to be an adjustment transverse to a flow direction through the housing 2 of the air vent 1.

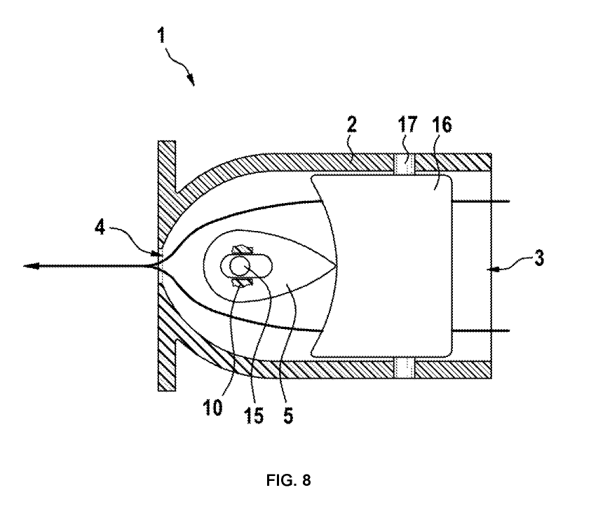

A housing 2 of the air vent 1 from FIGS. 8 to 10 is designed slightly differently from the housing 2 of the air vent 1 from FIGS. 1 to 4 and from FIGS. 5 to 7. Similarly to FIGS. 1 to 4 and FIGS. 5 to 7, the housing 2 of the air vent 1 from FIGS. 8 to 10 is tubular having a rectangular cross-section and tapering in an arc-shaped manner up to an air outlet opening 4. In contrast to FIGS. 1 to 4 and FIGS. 5 to 7, the housing 2 of the air vent 1 from FIGS. 8 to 10 does not widen between an air inlet opening 3 and the air outlet opening 4, but proceeding from the air inlet opening 3 initially has a constant, rectangular tube cross-section, before tapering in an arc-shaped manner, still with a rectangular tube cross-section, toward the air outlet opening 4, which is rectangular and can be considered to be slot-shaped.

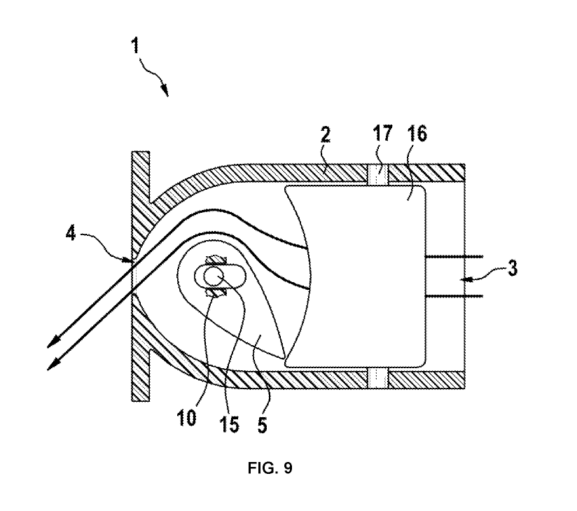

In a region tapering in an arc-shaped manner toward the air outlet opening 4, a flow-around body 5 having a symmetrical airfoil profile is disposed in the housing 2, however, this is not mandatory for the invention. The round end of the airfoil profile points to the air outlet opening 4, and the acute end points to the air inlet opening 3. The flow around the airfoil profile is thus exactly opposite to that around an aircraft wing. In FIGS. 8 to 10, the flow-around body 5 also forms an air-deflecting element 14 or an air-deflecting device 12 and can be pivoted about a pivot axis 15 that runs in the longitudinal direction of the flow-around body 5 and transversely to the housing 2, as well as transversely to a flow direction through the housing 2 of the air vent 1. As a result of pivoting about the pivot axis 15, the flow-around body 5, serving as an air-deflecting element 14, can be adjusted transversely to the flow direction through the housing 2, and thereby guide an air flow in an exit direction out of the air outlet opening 4. When the flow-around body 5 is pivoted downward, as seen in FIG. 9, air flows around this in the housing 2 at the top, wherein the air is initially deflected upward by the flow-around body 5 and subsequently downward by the housing 2 tapering toward the air outlet opening 4, so that the air flows obliquely downward out of the air outlet opening 4 of the housing 2 of the air vent 1. Expressed in general terms, the air flows obliquely out of the air outlet opening 4 in a direction that is opposite the direction in which the flow-around body 5 is adjusted or pivoted.

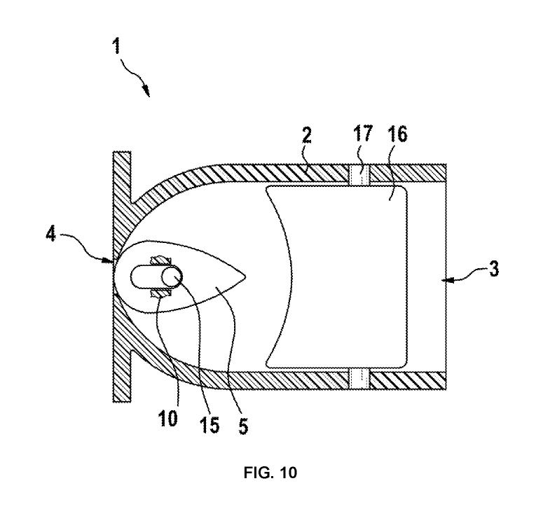

In FIGS. 8 to 10, the pivot axis 15 of the flow-around body 5 can be shifted by way of a longitudinal guide 10, designed as a sliding guide, in a longitudinal direction of the housing 2. In this way, the flow-around body 5 can be shifted into a closed position shown in FIG. 10, in which this closes the air outlet opening 4 of the housing 2 of the air vent 1. Due to the movement, which may also be considered a displacement, in the longitudinal direction of the housing 2, flow cross-sections at the top and at the bottom between the flow-around body 5 and the housing 2 can be decreased and increased, and thus an air volume flowing through the housing 2 of the air vent 1 can be controlled.

In a section of the housing 2 of the air vent 1 from FIGS. 8 to 10, mutually parallel louvers 16 are disposed next to one another between the air inlet opening 3 and the flow-around body 5. The louvers 16 are disposed perpendicularly to the flow-around body 5 and together can be pivoted about mutually parallel rotational axes 17 that are perpendicular to the pivot axis 15 of the flow-around body 5. The louvers 16 can be used to guide an air current through the housing 2 in a direction perpendicular to an air guidance direction of the flow-around body 5. Such louvers 16 can also be provided in the housings 2 of the air vents 1 from FIGS. 1 to 4 and 5 to 7 (not shown). The louvers 16, similarly to the flow-around body 5, form air-deflecting elements for guiding an air current in the housing 2 of the air vent 1, in particular out of the air outlet opening 4 in two mutually perpendicular direction.

The air vents 1 according to the invention can also be disposed vertically or obliquely instead of lying or horizontally, as shown. The flow-around body can then be displaced to the side, or obliquely to the side, and upward or downward, instead of upward or downward.

### LIST OF REFERENCE NUMERALS

### Air Vent for a Passenger Compartment of a Motor Vehicle

1 air vent
2 housing
3 air inlet opening
4 air outlet opening
5 flow-around body
6 rounded edge
7 sloped surface
8 end face
9 cross table
10 longitudinal guide
11 transverse guide
12 air-deflecting device
13 recess
14 air-deflecting element
15 pivot axis
16 louvers
17 rotational axis

1. An air vent for a passenger compartment of a motor vehicle, comprising a tubular housing, which includes an air inlet opening and an air outlet opening, and a flow-around body, which is disposed in the housing and displaceable in the housing in a flow direction through the housing and around which air flows when air flows through the housing, wherein the flow-around body can be displaced into a closed position closing the air outlet opening, and the air vent comprises an air-deflecting device, which can be adjusted in the housing transversely to the flow direction through the housing, whereby a ratio of an air volume of a flow through the housing on one side of the flow-around body to an air volume on an opposing side of the flow-around body changes.

2. The air vent according to claim 1, wherein the flow-around body can be displaced transversely to the flow direction through the housing of the air vent and forms the air-deflecting device.

3. The air vent according to claim 1, wherein the air-deflecting device comprises an air-deflecting element, which can be adjusted in the housing transversely to the flow direction through the housing.

4. The air vent according to claim 3, wherein the air-deflecting element is disposed in a recess of the flow-around body and, by way of adjustment, can be brought into a position in which it protrudes further from the flow-around body on the one side than on the opposite side.

5. The air vent according to claim 3, wherein the air-deflecting element has a W-shaped cross-section.

6. The air vent according to claim 1, wherein the flow-around body is located closer to the air outlet opening than to the air inlet opening.

7. The air vent according to claim 1, wherein the flow-around body has an airfoil profile.

8. The air vent according to claim 1, wherein the flow-around body has a widening, V-shaped profile including a rounded area instead of an edge on an incident flow side facing the air inlet opening and/or a trapezoidal profile on an outflow side facing the air outlet opening.

9. The air vent according to claim 1, wherein the housing and/or the air outlet opening have two different dimensions transverse to the housing or transverse to an air current through the housing.

10. that the air vent according to claim 1, wherein the flow-around body forms the air-deflecting device and, can be pivoted about a pivot axis extending transversely to the housing for the purpose of adjustment transverse to the flow direction through the housing of the air vent.
